(19) United States
(12) Patent Application Publication
(10) Pub. No.: US 2007/0222904 A1
(43) Pub. Date: Sep. 27, 2007

(54) Attachment System for Holding a Mirror in a Projection Display

(76) Inventors: Scott Joseph Duggan, Indianapolis, IN (US); Darin Bradley Ritter, Indianapolis, IN (US); Michel Alain Cadio, Carmel, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/578,221

(22) PCT Filed: Apr. 28, 2005
(86) PCT No.: PCT/US05/14519

§ 371 Date: Oct. 11, 2006

Related U.S. Application Data
(60) Provisional application No. 60/567,047, filed on Apr. 30, 2004.

(51) Int. Cl. H04N 9/31

(52) U.S. Cl. 348/789

(57) ABSTRACT

A projection display with a cabinet having a back wall with an outside face and an inside face, two support arms supporting the cabinet extending vertically along the outside face of the back wall of the cabinet and spaced apart a distance approximately equal to the width of the mirror is described. The cabinet has four raised pads formed on the inside face of the back wall proximate the support arms for locating the mirror, and the mirror is biased against the four pads to hold it in a vertical position.

### CROSS-REFERENCE TO RELATED APPLICATIONS

This application claims the benefit of U.S. Provisional Patent Application Ser. No. 60/567,047, entitled “Attachment System for Holding a Mirror in a Projection Display” and filed Apr. 30, 2004, which is incorporated by reference herein in its entirety.

### FIELD OF THE INVENTION

The invention relates generally to a projection display and, in particular to a mirror mounting system for a projection display.

### BACKGROUND OF THE INVENTION

Some new thin projection televisions with up-angle optics include a large mirror that is positioned in the back of a television cabinet parallel to the screen. Light is projected upwardly at an angle from a light engine disposed below the level of a screen for viewing the projected image. This light is reflected off of the mirror and onto the screen to form a viewable image. The mirror must stay reasonably flat or planar and survive drop testing It is important for this mirror to maintain its location as well as possible, because even small movement or dislocation can cause significant distortions of the viewable image due to the angle of the projection path.

Previous projection displays include angled mirrors, not mirrors that stand vertically. Standard techniques used to mount angled mirrors rely on gravity to hold the mirror against locating brackets. This arrangement does not work for a vertical mirror, as gravity will not hold a vertical mirror against the mounting brackets.

### SUMMARY OF THE INVENTION

The present invention provides projection display with a cabinet having a back wall with an outside face and an inside face, two support arms supporting the cabinet extending vertically along the outside face of the back wall of the cabinet and spaced apart a distance approximately equal to the width of the mirror. The cabinet has four raised pads formed on the inside face of the back wall proximate the support arms for locating the mirror, and the mirror is biased against the four pads to hold it in a vertical position.

### BRIEF DESCRIPTION OF THE DRAWINGS

The preferred embodiments of the present invention will be described with reference to the accompanying drawing figures, of which:

FIG. 1 is a perspective front view of a cabinet for a projection display according to an exemplary embodiment of the present invention;

FIG. 2 is a front view of the cabinet of FIG. 1 with brackets omitted for clarity;

FIG. 3 is an exploded perspective front view of an assembly of the cabinet of FIG. 1 with a mirror and bracket; and

FIG. 4 is a sectional view of the assembly of FIG. 3.

### DETAILED DESCRIPTION

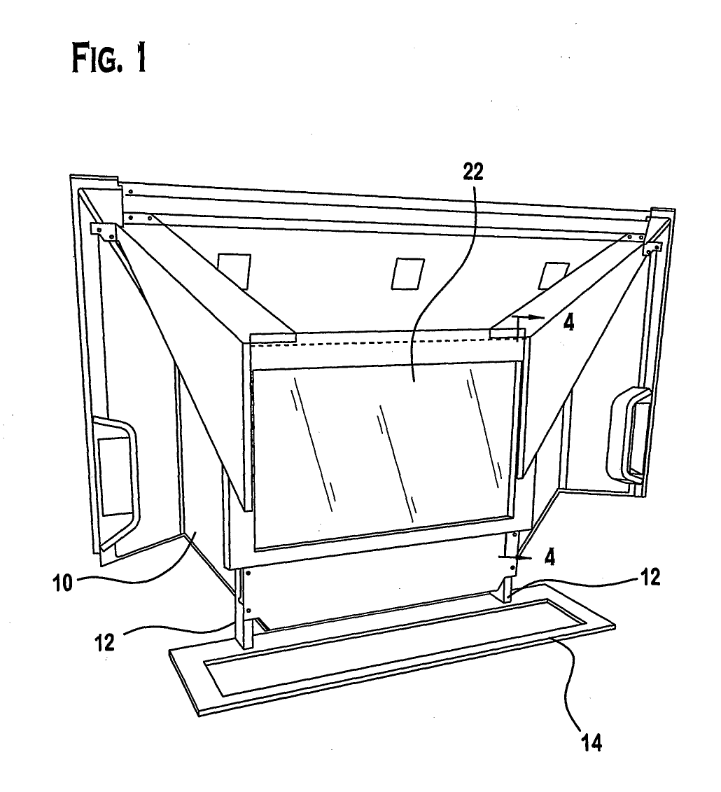

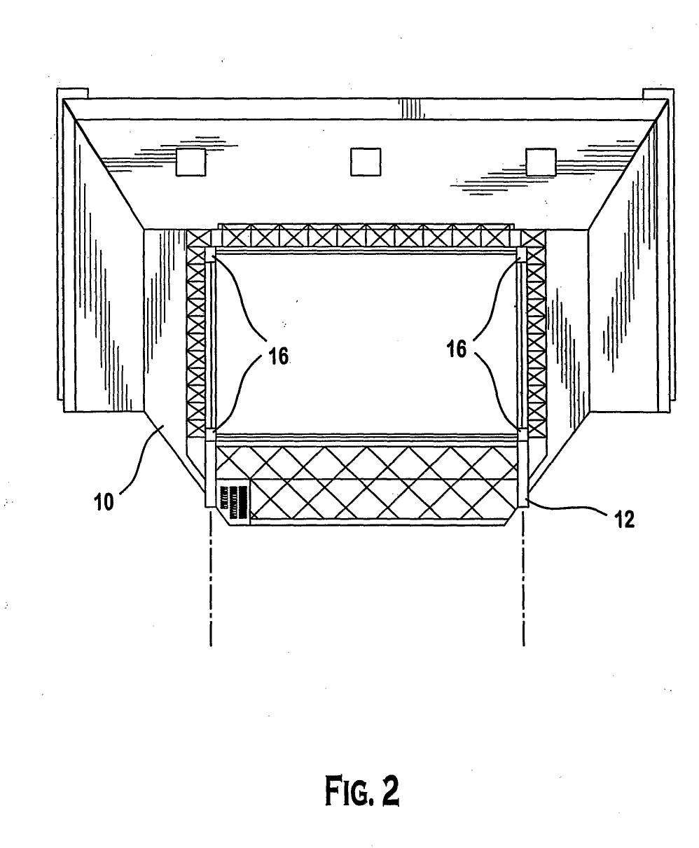

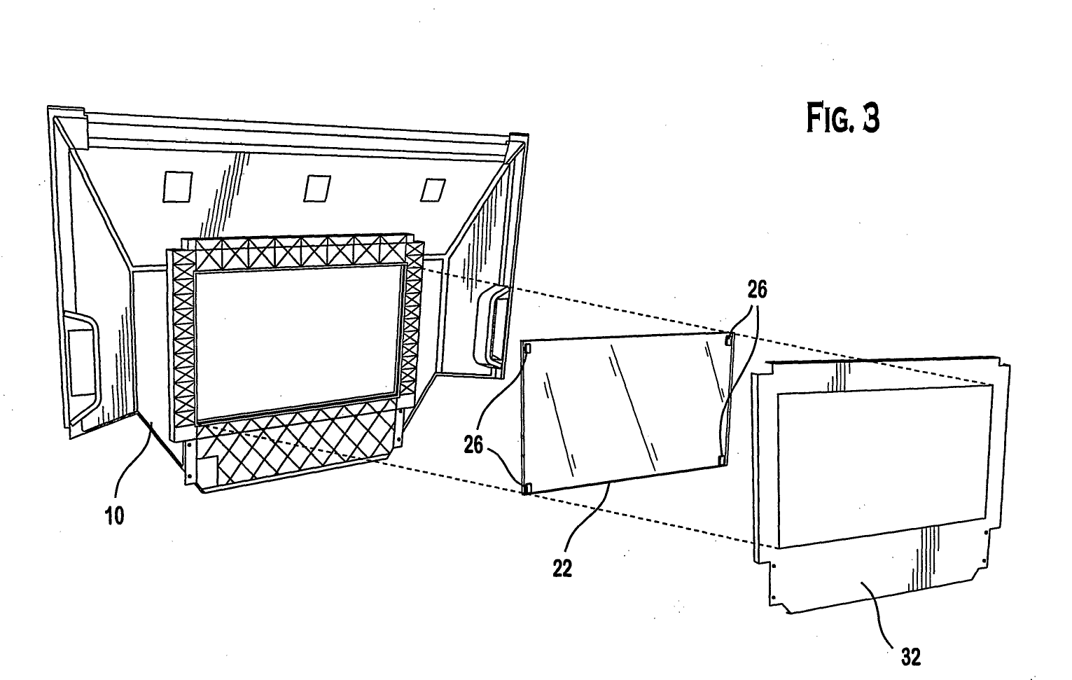

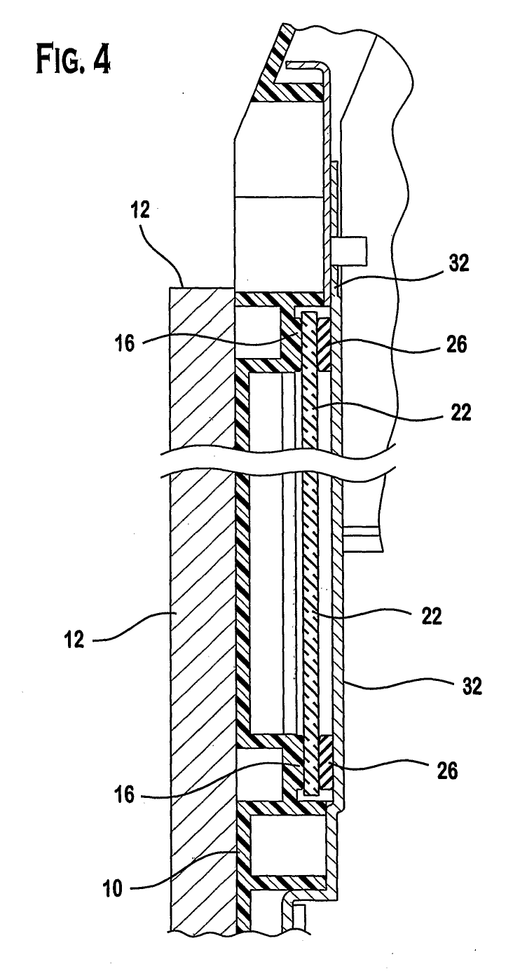

The present invention, shown in FIGS. 1-4, consists of a television cabinet 10 in which a mirror 22 stands vertically. The cabinet 10 has two structural rails or support arms 12 extending vertically along an outside face of a back wall of the cabinet. These support arms 12 are separated by approximately the width of the vertical mirror 22 and are used to mount the cabinet 10 to a stand 14 or a wall bracket (not shown). The areas of the cabinet where these support arms 12 extend are the only areas that are adequately supported with rigid structure members. A screen (not shown) is mounted to the front of the cabinet 10. In use, an image is reflected off of the mirror 22 and onto the screen.

The mirror 22 is fabricated in a manner that provides inherent flatness. For example a float glass process can be used, wherein hot glass is poured onto a dense liquid, so that it cools in a flat state, without residual stresses from supporting fixtures or the like. In an exemplary embodiment, the mirror is rectangular in shape having four corners.

To prevent introducing stresses into the mirror 22 that could cause it to distort the image projected onto the screen, the mirror 22 is fixed in the cabinet 10 at four discrete points proximate the support arms 12. This reduces tolerance stack-up problems and stresses induced by warpage of the plastic cabinet. The mirror is fixed to the cabinet at the corners of the mirror 22 and proximate the support arms 12 by four raised pads 16 formed in the cabinet. These four raised pads 16 are formed on the inside face of said back wall approximately over the area where the support arms 12 extend behind the back wall of the cabinet 10. The raised pads 16 provide a relatively small surface area that is not subject to movement due to warpage of the cabinet, because of their proximity to the rigid support arms 12. Moreover, these support pads can be provided with relatively tight dimensions because of their size and location. This is important because there are four pads, while only three points are required to define a plane. Thus, any deviation of the pads 16 from a plane will induce stress in the mirror, leading to distortion and degradation of the image projected onto the screen.

To maintain the mirror in a vertical orientation, the mirror 22 is biased against the four pads 16. The pads 16 are raised relative to surfaces intermediate the pads 16 so that the mirror is only restrained at the pads 16. The areas intermediate the pads 16 are recessed sufficiently to prevent contact with the mirror 22 during normal operation of the projection display, however, the dimension by which the pads 16 are raised is small enough to allow these intermediate surfaces to limit deflection of the mirror 22, enhancing the mirrors ability to survive impact, such as dropping and drop testing. In an exemplary embodiment, the pads 16 are raised to a height of between 1 mm and 2 mm above an intermediate surface of the cabinet wall along a short side of the mirror 22, and the pads 16 are raised to a height of between 2 mm and 3 mm above an intermediate surface of the cabinet wall along a long side of the mirror 22.

In an exemplary embodiment, the mirror 22 is biased against the pads 16 by a plurality of resiliently compressible members 26. The resiliently compressible members 26 comprise foam cushions in an exemplary embodiment, however other structures such as plastic springs are also possible. The resiliently compressible members 26 are positioned against the mirror opposite the pads 16, and may be adhered to the mirror 22 or a bracket 32 used to restrain the mirror 22. The resiliently compressible members 26 may be adhered by glue or adhesive, for example.

The bracket 32 is affixed to the cabinet 10 such that it overlies and compresses the resiliently compressible members 26, resiliently constraining the mirror 22 at its four corners. The bracket 32 may be an integral structure or may comprise a plurality of structural components. The mirror 22 is sandwiched between the four discrete raised pads 16 formed on the inside face of the back wall proximate the support arms 12 and the correspondingly located resiliently compressible members 26. A bottom edge of the mirror 22 is locally supported by pads (not shown) proximate each of the support arms.

The mounting system for the vertically standing mirror 22 allows the inherent flatness of the float glass mirror to bridge across the cabinet from support arm 12 to support arm 12. By molding four precision pads 16 over the support arms 12, good positioning for the mirror is achieved. The resiliently compressible members 26 work as springs to take up the tolerance and preload the mirror 22 against the molded cabinet pads 16. The bottom edge of the mirror may only sit on short plastic pads at each end to allow the mirror to freely span without being adversely influenced by warped plastic. The present invention provides a low cost mirror mounting system that minimizes tolerance stack issues and allows inherent flatness of the mirror to be utilized.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A projection display, comprising:
a cabinet having a back wall with an outside face and an inside face;
two support arms supporting said cabinet, the support arms extending vertically along a said outside face of said back wall of said cabinet and spaced apart a distance; and
a mirror having a width of approximately said distance disposed vertically in said cabinet;
wherein the cabinet has four raised pads formed on said inside face of said back wall proximate said support arms for locating said mirror, and wherein said mirror is biased against said four pads.

2. The projection display of claim 1, wherein the mirror is rectangular in shape having four corners and the mounting pads are located proximate the four corners of the mirror.

3. The projection display of claim 2, wherein the pads are raised to a height of between 1 mm and 2 mm above an intermediate surface of the cabinet wall along a short side of the mirror.

4. The projection display of claim 2, wherein the pads are raised to a height of between 2 mm and 3 mm above an intermediate surface of the cabinet wall along a long side of the mirror.

5. The projection display of claim 1, wherein the mirror is biased against the pads by a plurality of resiliently compressible members.

6. The projection display of claim 5, wherein the resiliently compressible members comprise foam cushions.

7. The projection display of claim 5 wherein the resiliently compressible members are positioned against the mirror opposite the pads.

8. The projection display of claim 7 wherein the resiliently compressible members are compressed by a bracket affixed to the cabinet.

9. A vertical mirror mounting arrangement for a projection display having two support arms affixed to and extending vertically along an outside face of a back wall of a cabinet and spaced apart a distance approximately equal to a width of the mirror, the arrangement comprising:
a mirror sandwiched between four discrete raised pads formed on an inside face of the back wall proximate the support arms for locating said mirror and correspondingly located resiliently compressible biasing members.

10. The mounting arrangement of claim 9, wherein the pads are raised to a height of between 1 mm and 2 mm above an intermediate surface of the cabinet wall along a short side of the mirror.

11. The mounting arrangement of claim 9, wherein the pads are raised to a height of between 2 mm and 3 mm above the intermediate surface of the cabinet wall along a long side of the mirror.

12. The mounting arrangement of claim 9, wherein the resiliently compressible members comprise foam cushions.

13. The mounting arrangement of claim 9, wherein the resiliently compressible members are compressed by a bracket affixed to the cabinet.

14. The mounting arrangement of claim 9, wherein a bottom edge of the mirror is locally supported by pads proximate each of the support arms.
